(19) United States
(12) Patent Application Publication
(10) Pub. No.: US 2024/0109225 A1
(43) Pub. Date: Apr. 4, 2024

(54) METHOD OF INJECTING POLYURETHANE IN PRE-INSULATED PIPES AT THE POINTS OF JOINING WITH FITTINGS

(71) Applicant: ANASTASIOS RIZOPOULOS, VASILIKA THESSALONIKIS (GR)

(72) Inventor: ANASTASIOS RIZOPOULOS, VASILIKA THESSALONIKIS (GR)

(21) Appl. No.: 18/273,281

(22) PCT Filed: Jan. 13, 2022
(86) PCT No.: PCT/GR2022/000002

§ 371 Date: Jul. 20, 2023

(30) Foreign Application Priority Data
Jan. 21, 2021 (GR) 20210100039

(51) Int. Cl. B29B 7/74; B29B 7/32; B29B 7/76; B29C 44/36; B29C 65/00

(52) U.S. Cl. CPC B29B 7/7447; B29B 7/325; B29B 7/761; B29C 44/367; B29C 66/522; B29C 66/861; B29K 2075/00

(57) ABSTRACT

The invention relates to a method of injecting polyurethane, where the contents of two cylinders (2) of polyol and isocyanate are mixed in a static mixer (3). The mixed amount of polyurethane is injected with a gun (1) into a hole and at the appropriate points for joining the fittings. The injection can be done in horizontal hanging lines that run through the roof, in vertical columns, but also in any other case as judged by the applying person.

### FIELD OF ART

The invention relates to the field of application technique and in particular to the field of plastic shaping and more particularly to the shaping and bonding of plastics or to the shaping of materials in a plastic state. In particular it refers to specific shaping techniques and even more specifically to a method of injecting polyurethane into insulated pipes at the joints with fittings.

### BACKGROUND OF THE INVENTION

The method of injecting polyurethane in pre-insulated pipes at the joints with fittings disclosed in the present invention has not been disclosed in the prior art.

To date, the recommended injection procedure is to pump out an equal amount of polyol and isocyanate using a syringe, stir for a few seconds and then inject the mixture into the hole in the mantle. This method, although generally accepted and widely used, has shown major drawbacks. Initially, in difficult places, such as the horizontal hanging lines running through the roofs, as well as the vertical columns, it was extremely difficult to inject and stabilize immediately, without any unwanted flow. In addition, the exact amounts of isocyanate and polyol are not guaranteed but depend on the technician, with the result that often the dosages are incorrect and the result is doubtful. Furthermore, the completion of the process presents significant delays while at the same time cleaning issues are raised for the pipe and the applying person.

It is thus an object of the present invention to advantageously deal with the aforementioned disadvantages and shortcomings of the prior art by proposing a method of injecting polyurethane into pre-insulated pipes at the joints with the fittings.

A further object of the present invention is to provide a method of injecting polyurethane into pre-insulated pipes which can be applied to both fast expanding and slow expanding polyurethane.

It is a further object of this invention to provide a method of injecting polyurethane which ensures easy injection in difficult areas, such as horizontal hanging lines running through building roofs and the vertical columns.

A further object of the invention is to provide a method that ensures accurate dosing of a mixture of the two components, technically improving the final result.

A further object of the invention is to present a method of injecting polyurethane into pre-insulated pipes at the joints with the fittings where the process is completed in less time than the known methods.

These and other objects, features and advantages of the invention will become apparent in the following detailed description.

### BRIEF DESCRIPTION OF THE DRAWINGS

The invention will become apparent to those skilled in the art with reference to the accompanying drawings in which it is illustrated in a non-limiting manner.

FIG. 1 shows a side view of the gun used to apply the injection method.

FIG. 2 shows in perspective view the pistol with the pair of cylinders used in the present method.

### DETAILED DESCRIPTION OF A PREFERRED EMBODIMENT

Referring now to the accompanying drawings, we will describe illustrative embodiments of the polyurethane injection method in pre-insulated pipes at the joints with fittings.

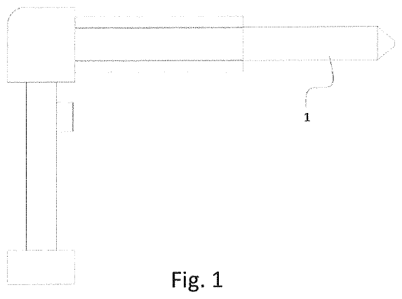

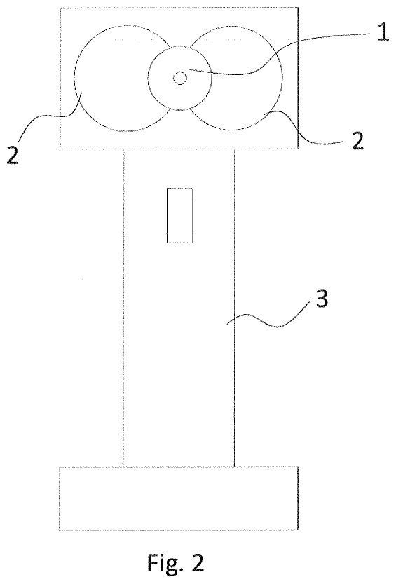

The method is carried out with a gun (1), FIG. 1, having a pair of cylinders (2) and a static mixer (3), FIG. 2. An equal amount of polyol and isocyanate is placed in each bottle (2) of the gun (1). Each cylinder (2) has a dosing scale for proper adjustment. The static mixer (3) ensures the mixing of the two components and the geometry of the static mixer (3) helps to make injections in difficult areas. The polyurethane, resulting from the mixing of polyol and isocyanate, is applied in the hole, taking care that the level of the scale of the pair of cylinders (2) reaches the corresponding marking.

It should be noted at this point that the description of the invention has been made with reference to non-limiting embodiments. Therefore, any change or modification in terms of shape, dimensions, morphology, materials used and components of construction and assembly, as long as they are not a new inventive step and do not contribute to the technical development of the already known are considered to be contained in the purposes and aspirations of the present invention.

1. A method of injecting polyurethane into pre-insulated tubes at joints with fittings, where the contents of two cylinders (2) of isocyanate and polyol are mixed in a static mixer (3), characterized in that the resulting polyurethane is injected through a gun (1) into holes for joining pre-insulated pipes with fittings.
